(19) United States
(12) Patent Application Publication
(10) Pub. No.: US 2004/0229045 A1
(43) Pub. Date: Nov. 18, 2004

(54) Process for the preparation of a coating, a coated substrate, an adhesive, film or sheet

(75) Inventors: Laurentius Cornelis Josephus Hesselmans, 's-Hertogenbosch (NL); Johanna Antonia Maria Van den Goorbergh, Waalwijk (NL); Andries Johannes Derksen, Nijmegen (NL)

Correspondence Address: PEACOCK MYERS AND ADAMS P C, P O BOX 26927, ALBUQUERQUE, NM, 871256927

(73) Assignee: STAHL INTERNATIONAL B.V., Waalwijk (NL)

(21) Appl. No.: 10/783,340

(22) Filed: Feb. 20, 2004

Related U.S. Application Data
(63) Continuation of application No. PCT/NL02/00554, filed on Aug. 21, 2002.

(30) Foreign Application Priority Data
Aug. 22, 2001 (NL) NL1018797

(51) Int. Cl. B05D 3/02; B32B 27/40

(52) U.S. Cl. 428/422.8; 427/372.2; 428/423.1

(57) ABSTRACT

A process for the preparation of a coating, coated substrate, film or sheet, in which process a coating mixture comprising a reactive system of polyisocyanate-functional, a polyketone-functional, a polyepoxide-functional, a polyanhydride-functional and/or a poly carbonate-functional compound or polymer and a dispersion or fine powder of a compound containing a reactive hydrogen, which mixture is not or low reactive at room temperature, is applied onto a substrate, resulting in a substrate coated with the coating mixture, followed by reacting the compounds mentioned above by elevating the temperature, in a substrate coated with the coating mixture, followed by reacting the compounds mentioned above by elevating the temperature, in which the reaction temperature and consequently the reaction rate can be adjusted as desired by the addition of an additive to the coating mixture, or to one of the reactants of the coating mixture, prior to the mixing with the other component. According to the invention optionally a second reactive system is present and both systems are essentially reacted as a sequential two step reaction and between these reaction steps the coating is remoulded. The invention further comprises a product obtained by the process.

The invention relates to a process for the preparation of a coating, coated substrate, adhesive, film or sheet, to the thus obtained product and to the coating mixture to be used in the process.

In the course of years several methods have been developed for solvent-free application of polyurethanes in the preparation of coatings, films and the like. An overview of these methods is presented in WO-123451. In this patent application an invention is described which caused a breakthrough in the development of high solid systems. This invention describes a process for the preparation of coatings in which a mixture of a polyisocyanate-, polyepoxide-, polyanhydride-, or polyketone-functional compound and a compound containing a reactive hydrogen, which mixture is not reactive at room temperature, is applied onto a substrate, whereafter the mixture reacts at elevated temperatures from 30-300° C. The compound containing a reactive hydrogen is a solid, which may be present in the mixture as a fine powder or as a dispersion in a medium.

Another new method in the field of developing high solid content systems is described in the Dutch patent application no 1018797. It relates to a combination of the system described above and another reactive system. A problem of these known systems is that for certain applications a lower reaction temperature is required, while in addition the pot-life of the coating mixture must be sufficiently long. An example of this is the application to temperature-sensitive substrates, such as leather. Other applications have the disadvantage that a higher reaction temperature is required. An example is the application in a two-step reaction in which an early start of the second reaction-step has to be prevented.

EP-171015 describes a method of delaying the reactions between polyisocyanate and aromatic diamines or, at ambient temperature, solid aliphatic diamines by surrounding the same with a polymer layer, in particular with a polyurethane layer, which melts when the temperature is elevated, whereafter the diamine can react. A disadvantage of this invention is that it does not relate to hydrazides, which are known to yield strong films and to be anti-yellowing. Moreover the reaction time is from 1-2 hrs to possibly 1-2 days, also at higher temperatures, which is much too long in the coating industry. In addition, the considerable disadvantage of the polyurethane films which are formed by using aromatic diamines is that they yellow easily and the diamines themselves are mutagenic and/or carcinogenic.

The object of the present invention is to provide a process in which the disadvantages mentioned are eliminated effectively.

According to the present invention there is provided a process for the preparation of a coating, coated substrate, adhesive, film, sheet and the like, in which process a coating mixture which comprises a reactive system of a polyisocyanate-functional, polyketone-functional, polyepoxide-functional, polyanhydride-functional and/or polycyclic carbonate-functional compound or polymer and a dispersion or fine powder of a compound containing a reactive hydrogen, which mixture is not or low-reactive at room temperature, is applied onto a substrate, resulting in a substrate coated with the coating mixture, followed by reacting the compounds mentioned above by elevating the temperature, characterized, in that the reaction temperature and consequently the reaction rate can be adjusted as desired by the addition of an additive to the coating mixture, or to one of the reactants of the coating mixture prior to the mixing with the other component, and in which optionally another reactive system is present and both systems are essentially reacted as a sequential two step reaction while between these reaction steps the coating is remoulded. Such a remoulding may be the application of a grain or a fold.

Preferably the compound containing the reactive hydrogen is a compound which is crystalline at a temperature below 30° C. At grinding the compound or dispersing it in a non-reactive material it maintains its crystalline form.

Preferably the compound containing reactive hydrogen is a polyhydrazide and/or polysemicarbazide and/or piperazine, while, most preferably, the compound is adipic dihydrazide and/or carbodihydrazide. Preferably these compounds are present as a dispersion in a non-reactive material as described in WO-123451.

Usually the additive is water, acid, base, a metal catalyst, a solvent, a polyisocyanate-functional compound, a polyketone-functional compound, a melamine and/or a surfactant.

Surprisingly it appeared that several factors are of importance in the adjustment of the reaction such as, the concentration of the additive, the sequence of the addition of the additives, the separate addition of the additives to one of the reactants of the coating mixture prior to mixing of these reactants, the equilibration time of the additives in the coating mixture or in one of the reactants of the coating mixture.

In particular it appeared that the reaction rate is increased by the addition of water, a polar non-protic organic solvent, an acid, a base, a metal catalyst, and/or a surfactant to the coating mixture, and a coating is formed at a temperature which is 3-50° C. below the original reaction temperature; which is the conventional temperature which is needed for the formation of the coating. A great advantage of this adjustment of the process is that the process is now also suitable for temperature-sensitive substrates, such as leather. A second advantage is that at lower temperatures the energy costs for preparing a coating are lower.

Surprisingly it appeared that the reaction is delayed when 0.0001-10% by weight of water and/or acid and/or an amine, polyamine, alcohol or polyol is not added to the coating mixture, but first to a dispersion of the compound containing the reactive hydrogen, prior to mixing it with a polyisocyanate-functional compound, and a coating is formed at a temperature that is 3-50° C. higher than the original reaction temperature. An explanation for this is that when the water- and/or acid-, amine-, polyamine-, alcohol-, or polyol-containing dispersion is mixed with a polyisocyanate-functional compound, the compound containing a reactive hydrogen is preferably surrounded by a thin layer of the water and/or acid, amine, polyamine, alcohol or polyol, because of the strong polar or hygroscopic character of the particles. A part of the compound containing a reactive hydrogen dissolves in this thin layer and reacts immediately with the polyisocyanate, the moment that it makes contact with the polyisocyanate. As a consequence a thin ureum- or urethane-oligomer layer is formed surrounding the rest of the particle, which is a barrier for the rest of the polyisocyanate. In the case that an amine, polyamine, alcohol or polyol is present in the dispersion, these compounds also react completely or partially with the polyisocyanate and contribute to the formation of the thin barrier layer. At increasing the temperature the barrier is broken and the rest of the polyisocyanate-functional compound and the rest of the compound containing a reactive hydrogen react further. The part of the compound containing a reactive hydrogen which is dissolved does react at room temperature, because this is mono-molecular material and is not fixed in the crystalline form.

The addition of 0.001-0.2 equivalents of a polyisocyanate-functional compound, such as 1,6-hexanediisocyanate, toluenediisocyanate, 4,4,-diisocyanatocyclohexylmethane, 4,4,-diisocyanatophenylmethane, 3-isocyanatomethyl-3,5,5,-trimethylcyclohexylisocyanate, tetramethylxylenediisocyanate, a (triisocyanatoalkyl- or cycloalkyl)-isocyanurate, a (diisocyanato-alkyl- or cycloalkyl)uretdion, or an isocyanate-functional polyurethane based on the mentioned diisocyanates, and/or an aliphatic or aromatic polycarbodiimide and/or an organic solvent, to a dispersion of the compound containing a reactive hydrogen, prior to the mixing with the polyisocyanate-functional compound also delays the reaction and a coating is formed at a temperature that is 3-50° C. higher than the original reaction temperature.

According to the process the reaction is also delayed by the addition of 0.001-0.2 equivalent of one of the polyisocyanate-functional compounds with a low molecular weight described above, to a polyisocyanate-functional polyurethane, prior to the mixing with the compound containing a reactive hydrogen and a coating is formed at a temperature that is 3-50° C. higher than the original reaction temperature.

An explanation for the need to increase the reaction temperature for both cases described above is, that after the addition of 0.002-0.2 equivalents of a polyisocyanate-functional compound, or an aliphatic or aromatic polycarbodiimide, to the dispersion with the compound containing a reactive hydrogen or, after the addition of 0.001-0.2 equivalent of one of the mentioned low-molecular polyisocyanate-functional compounds to an isocyanate-functional polyurethane, the polyisocyanate-functional compound, respectively the polycarbodiimide reacts with the borderline molecules of the particle with the reactive hydrogen and a thin ureum- or urethane-oligomer layer, respectively an acylureum-oligomer layer is formed around the rest of the particle, which forms a barrier for the rest of the polyisocyanate. At increasing the temperature the barrier is broken and the rest of the polyisocyanate-functional compound and the rest of the compound containing a reactive hydrogen react.

In EP-171015 a comparable process is used with aromatic diamines and solid aliphatic polyamines which are surrounded by a polyurethane layer. However, the polyhydrazides and semicarbazides and carbodihydrazide, which are applied in the present invention, have unique properties compared to the polyamines mentioned, especially when they are applied in a solid form. The main reason for this is that, because of the morphological properties of the polyhydrazides, polysemicarbazides and carbodihydrazide, they are completely inert at room temperature and even at temperatures up to and above 50° C. they are often inert in both, reactive and non-reactive, media. In conventional applications they are used as chain extender or as crosslinker in the preparation of polyurethanes, just like aliphatic or aromatic polyamines. They have a reactivity comparable to that of the aliphatic polyamines when they are dissolved in water or in an organic solvent. However, when the polyhydrazides and semicarbazides are in the solid form, the obtained mixtures with a polyisocyanate-functional compound have a long pot-life, and sometimes even an unlimited pot-life, as described in WO-123451, while aliphatic amines, also when they are solid, already react with a polyisocyanate during the mixing with a polyisocyanate and a gel is formed immediately. When in a comparable way as in EP-171015 and according to the description above an aliphatic polyamine is surrounded by a polyurethane layer, and the protected polyamine is mixed with a polyisocyanate, the mixture does reacts within 1 minute. In the first place, this means that the crystal energy of the polyhydrazides, semicarbazides and carbodihydrazide is much higher than that of the aliphatic polyamines. In the second place, it is much more difficult to break the barrier of the oligomer layer in which a polyhydrazide, polysemicarbazide or carbodihydrazide is used, than when an aliphatic amine is used.

Further, it is known that the reactivity of polyhydrazides, polysemicarbazides or carbodihydrazide, when they are dissolved in water or in an organic solvent, is much greater than that of aromatic polyamines towards polyisocyanates. Yet, according to EP-171015 and the references cited therein, the aromatic polyamines in a solid form have to be protected somehow to obtain a sufficient pot-life when mixed with a polyisocyanate. As mentioned before, this is not required for polyhydrazides, semicarbazides and carbodihydrazide. When applying the protected aromatic polyamines, the reaction mixture with the polyisocyanate is heated for 1 to 2 hrs at 120-140° C., and sometimes even for 1 to 2 days at a temperature of 110 to 120° C. to break the barrier layer and to obtain a complete reaction. These reaction times are far too long in the coating industry. A reaction time of 2 to 3 minutes is required at a temperature of 50 to 200° C. and preferably at 50 to 160° C. Surprisingly it appeared that in the application of the polyhydrazides, polysemicarbazi-des and carbodihydrazide which have a barrier layer according to the invention, a complete reaction with a polyisocyanate can be obtained in the same time as with the unprotected material. Usually this time is from 2 to 3 min at 50 to 160° C. and depends on the type of polyisocyanate, whether a polyhydrazide, polysemicarbazide or carbodihydrazide is used and on the type of application. The reaction temperature of the reaction mixtures, in which the polyhydrazide, polysemicarbazide or carbodihydrazide is protected by a barrier layer, may be higher than in the absence of such a layer, but the reaction is immediate and complete.

The use of polyhydrazides, polysemicarbazides and carbodihydrazide is advantageous for several reasons, both in the protected form as well as in the pure form. In the first place, in the reaction with polyisocyanates very strong, resistant and non-yellowing films are obtained. Unlike aliphatic or aromatic polyamines these compounds do not have a penetrating smell and they are not corrosive. An important advantage, particularly with respect to aromatic polyamines, is that the polyhydrazides, polysemicarbazides or carbodihydrazide are not mutagenic and/or carcinogenic.

According to the process the reaction is further delayed by the addition of 0.001 to 0.20 equivalents of an aldehyde-, polyaldehyde-, ketone- and or polyketone-functional compound to a dispersion of the compound containing a reactive hydrogen, prior to mixing with a polyisocyanate-functional compound, and a coating is formed at an reaction temperature which is 3-50° C. higher than the original reaction temperature.

In an analogous way as with the addition of polyisocyanates a barrier is formed, which in this case is a polyimine layer or a polyhydrazone layer. The ketone functional compound which is used as additive is preferably a dialkyl ketone, a cycloalkyl ketone, an alkanal, a polyketone-alkane, -cycloalkane or -aromatic, or a ketone-functional polymer with ketone functions in the main chain or in the side chain, such as a ketone-functional polyesterdiol, polyacrylate or polyurethane.

Many of the coating mixtures of the polyhydrazide or polysemicarbazide with a polyisocyanate have a pot-life of at least 3 weeks. However, the pot-life of some of them is shorter, in particular when carbodihydrazide is used as the compound containing a reactive hydrogen. A second effect of the addition of water and/or acid, an amine, a polyamine, an alcohol, a polyol, or of the addition of 0.002 to 0.20 equivalents of a polyisocyanate-functional compound to a dispersion containing a reactive hydrogen, prior to mixing with the polyisocyanate functional compound, or of 0.001-0.20 equivalent of a polyketone-functional compound, or of 0.002-0.2 equivalent of a low molecular polyisocyanate-functional compound to a isocyanate-functional polyurethane, is that the pot-life of the coating mixture is increased from 5-240 min up to at least 1 day and preferably to at least 14 days.

As mentioned before, there is possible a second reactive system present. It comprises on the one hand a ketone, anhydride, epoxide, a polyisocyanate with a different reactivity, a blocked isocyanate and/or a cyclic carbonate function, or the compound with the isocyanate functionality, and on the other hand a hydrazide or semicarbazide with a lower reactivity or with a different particle size, an amine, a hindered amine, chlorinated amine, a polymer protected amine, a blocked amine, azetidine, aspartate, carboxyl, aromatic amine, hydroxide and/or melamine function, and/or the other reactive system comprises polysiloxane or melamine functions, which are polymerisable by self-condensation, and/or the other reactive system comprises an unsaturated compound which undergoes an addition polymerisation, in which the reactive groups from the second reactive system may be coupled to the compound containing the reactive hydrogen, or to the polyisocyanate-functional, a polyketone-functional, a polyepoxide functional, a polyanhydride functional, and/or a polycarbonate-functional compound or polymer of the first reactive system or to another compound.

According to the invention it is possible that the second reactive system reacts faster than the first reactive system in the presence of the mentioned additives.

Another option is that the reaction of the second reactive system is slower than that of the first reactive system in the presence of the mentioned additives.

In WO 0123451 an overview is presented of the isocyanate-functional and/or ketone-functional and/or epoxide-functional, and/or anhydride-functional compounds which may be used in the invention and of the ways that the coating mixtures may be applied. Naturally, the compounds may contain non-reactive groups such as allophenate groups, biurete groups, isocyanurate groups, and reactive groups such as carbodiimide groups or unsaturated groups.

The invention further extends to the product obtained by the process, such as a coating, coated substrate, film or sheet.

The present invention is further illustrated by the following examples to which the invention is however not limited. It goes without saying that numerous other embodiments are possible, all within the scope of protection.

### EXAMPLES

The following abbreviations and commercial names will be used in the examples:

HDI: 1,6-hexanediisocyanate

TDI: 2,4-toluenediisocyanate or 2,6-toluenediisocyanate or mixtures of these isomers

IPDI: 3-isocyanatomethyl-3,5,5-trimethylcyclohexylisocyanate

Des W: 4,4′-diisocyanatocyclohexylmethane

N-3300: Desmodur N-3300; a trisocyanurate based on HDI from Bayer

ADH: adipic dihydrazide

CDH: carbodihydrazide

Triton X-100: non-ionic emulsifier obtainable from Union Carbide

Marlipal O 13/120: non-ionic emulsifier obtainable from condea

Aerosol OT 100: anionic emulsifier obtainable from Cytec

Synperonic: Synperonic PE-L62/LF; a block polymer of ethylene- and propyleneglycol obtainable from PUK.

Bisoflex TOT: a polyester obtainable from Laporte

PEC-205: a polyketonediol obtainable from Neoresins

NMP: N-methylpyrolidinone

MEK: methylethylketone (butanone)

EtOAc: ethyl acetate

DMM: dimethyl ether of dipropyleneglycol

EAP: ethyl-acid phosphate

DABCO: diaminobicyclo-octanoate

DBTL: dibutyltin laureate

SA: stoichiometric amount

### Example 1

### Preparation of an Aliphatic Isocyanate-functional Polyurethane Polymer

Under a nitrogen atmosphere 126.5. g (752.98 mmol) of HDI was added at 60-70° C. to a mixture of 358.49 g (400 mmol) of polypropylene glycol with a molecular weight of 1007, 5.0 g (37.31 mmol) of trimethylolpropane and 10.0 g (96.0 mmol) of 2,2-dimethyl-1,3-propanediol while stirring. The mixture was heated to 90° C. and was reacted for two hours at this temperature, forming an isocyanate-functional polyurethane. After 1 hr of reaction time 0.1 g of tinoctoate was added as a catalyst. The reaction mixture was cooled down. The remaining NCO-content was measured and was 3.98% by weight.

### Example 2

### Preparation of an Aromatic Isocyanate-functional Polyurethane

The procedure of Example 1 was repeated, with the exception that an isocyanate-functional polyurethane was prepared from 129.2 g (742.53 mmol) of TDI, 658.76 g (658.76 mmol) of polypropylene glycol with a molecular weight of 2000 and 12.0 g (89.55 mmol) of trimethylolpropane. The reaction temperature was 85° C. The remaining NCO-content was measured and was 2.57% by weight.

### Example 3

### Preparation of an Aliphatic Isocyanate-functional Polyurethane

The procedure of Example 1 was repeated, with the exception that an isocyanate-runctional polyurethane was prepared from 112.78 g (507.56 mmol) of IPDI, 139.21 g (138.24 mmol) of polypropylene glycol with a molecular weight of 1007, 163.77 g (81.89 mmol) of polypropylene glycol with a molecular weight of 2000 and 4.2 g (31.34 mmol) of trimethylolpropane. The reaction temperature was 100° C. The remaining NCO-content was measured and was 4.43% by weight.

### Example 4

### Preparation of an Isocyanate-functional Polyurethane Containing Incorporated Unsaturated Groups

Under a nitrogen atmosphere 4.55 g of a hydroxypolyesteracrylate (obtainable as Tone M-100 from Union Carbide) and 0.02 g of dibutyltindilaureate were added to 120 g of the product of Example 3 while stirring. The mixture was stirred for 1.5 hr at 90° C. and cooled down. The remaining NCO-content was 3.40%. Just before testing the product in Example 12, 0.4 g of an UV-initiator (CGI-1800 van Ciba) in 4 g of dipropyleneglycol-dimethylether was stirred into 50 g of the product.

### Example 5

### Evaluation of the Effect of the Addition of Water or N-methylpyrrolidinone to a Coating Mixture on the Reaction Temperature Needed for the Formation of a Polyurethane Coating

The isocyanate-functional polyurethane of Example 1, 2 or 3 was mixed with a, with respect to the NCO-content, equivalent amount of a 4:6 (w/w) dispersion of carbodihydrazide or adipic dihydrazide in Bisoflex TOT. Beforehand an amount of water or NMP was mixed into the isocyanate-functional polyurethane. 500 μm of the obtained mixture was spread onto a pre-heated plate. The temperature was raised serially with 5° C. (±1° C.) at a time. After 3 min the progress of the reaction was checked. The lowest temperature required to obtain a dry and flexible film was measured. The results are presented in Table A.

TABLE A
Effect of water or NMP on the coating formation
using an isocyanate-functional polyurethane and a
carbodihydrazide dispersion or an adipic dihydrazide
dispersion.

| | | | minimal | |
|---|---|---|---|---|
| | | compound | temperature | |
| | Added to the | containing | complete curing | pot-life^{a)} |
| | polyurethane | reactive | within 3 min | at 20° C. |
| Polyurethane | (weight %) | hydrogen | (° C.) | (min) |
| Example 1 | — | CDH | 90 | >6000 |
| | 0.5% water | CDH | 80 | 40 |
| | 1.0% water | CDH | 80 | 9 |
| | 3.0% water | CDH | 70 | 3 |
| | 2.0% NMP | CDH | 90 | 20-40 |
| | 5.0% NMP | CDH | 80 | 20-40 |
| | 20% NMP | CDH | 70 | 5 |
| | 5.0% isohexane | CDH | 90 | >200 |
| | 20% isohexane | CDH | 90 | >200 |
| | 2.0% EtOAc | CDH | 90 | >200 |
| | 5.0% EtOAc | CDH | 85 | >120 |
| | 20% EtOAc | CDH | 80 | 25 |
| | 5.0% toluene | CDH | 85 | >180 |
| | 20% toluene | CDH | 85 | 50 |
| | 5.0% MEK | CDH | 85 | >180 |
| | 20% MEK | CDH | 80 | 30 |
| | 5.0% DMM | CDH | 85 | >60 |
| | 20% DMM | CDH | 85 | 30 |
| | — | ADH | 120 | >6000 |
| | 1% water | ADH | 120 | 300 |
| | 3% water | ADH | 120 | 90 |
| Example 2 | — | CDH | 95 | >6000 |
| | 1.0% water | CDH | 80 | 10 |
| | 3.0% water | CDH | 75 | 0.7 |
| | 5.0% water | CDH | 70 | <0.3 |
| Example 3 | — | CDH | 90 | 120 |
| | 1.0% water | CDH | 85 | 12 |
| | 3.0% water | CDH | 80 | <3 |
| | 5.0% water | CDH | 80 | <3 |
| | 5.0% NMP | CDH | 95 | 30 |
| | — | ADH | 125 | >6000 |
| | 1.0% water | ADH | 120 | 30-60 |
| | 3.0% water | ADH | 120 | 30-60 |

Remarks relating to Table A:
^{a)}pot-life of the coating mixture

The results show that

by the addition of water to an isocyanate-functional polyurethane the minimal reaction temperature for the formation of a coating can be decreased. The effect is stronger with a HDI-based polymer or TDI-based polymer than with a IPDI-based polymer and the effect is also stronger with a higher percentage of water.

the pot-life of the coating mixture is shorter when water is added to the isocyanate-functional polyurethane.

the addition of solvents has a marginal effect on the reaction temperature; a lower reaction temperature can only be reached by the addition of a larger amount of NMP.

the pot-life drastically decreases by the addition of solvents, in particular in larger amounts.

the effects with CDH are more explicit than with ADH.

### Example 6

### Evaluation of the Effect of Various Additives to a Coating Mixture on the Reaction Temperature Needed for the Formation of a Polyurethane Coating

The procedure of Example 5 was repeated with several components which were added either to the isocyanate-functional polyurethane, or to the dispersion of carbodihydrazide. Further a dispersion of CDH in the water-soluble Synperonic PE-L62/LF was tested. In this case the isocyanate-functional polyurethane of Example 3 was used. The results are presented in Table B.

TABLE B
Effect of additives on the coating formation
using the aliphatic isocyanate-functional polyurethane of
Example 3 and a carbodihydrazide dispersion.

| | | minimal | |
|---|---|---|---|
| | | temperature | |
| | | complete | |
| Additive added to | Additive added to | curing | pot-life^{a)} |
| the CDH-dispersion^{c)} | the polyurethane | within | at 20° C. |
| (weight %) | of Example 3 | 3 min (° C.) | (min) |
| — | — | 90 | 60-90 |
| — | 1% water | 85 | 12 |
| — | 5% water | 80 | <3 |
| — | 5% NMP | 95 | ˜30 |
| 1% Marlipal O 13/120 | — | 90 | <2 |
| 1% Marlipal O 13/120 | 5% water | 80 | <2 |
| 5% Marlipal O 13/120 | — | 90 | <3 |
| 5% Marlipal O 13/120 | 5% water | 75 | <3 |
| 1% Aerosol OT 100 | — | 90 | 30-40 |
| 1% Aerosol OT 100 | 5% water | 80 | 1 |
| 5% Aerosol OT 100 | — | 95 | 30-40 |
| 5% Aerosol OT 100 | 5% water | 75 | 1 |
| 5% Aerosol OT 100 | 5% NMP | 80 | 0.8 |
| — | 0.1% HDI | 95 | <1^{d)} |
| — | 0.5% HDI | 95 | 4^{d)} |
| — | 1.0% HDI | 90 | 196^{d)} |
| — | 1.0% HDI^{b)} | 110 | — |
| — | 2.0% HDI | 100 | 196^{d)} |
| — | 2.0% HDI^{b)} | 120 | — |
| — | 2.0% TDI | 120 | >288^{d)} |
| — | 2.0% IPDI | 95 | 1-3^{d)} |
| — | 2.0% Des W | 95 | 1-2^{d)} |
| CDH-dispersion in | — | 95 | 40-60 |
| Synperonic | | | |
| CDH-dispersion in | 1% water | 90 | 10-15 |
| Synperonic | | | |
| CDH-dispersion in | 5% water | 85 | <2 |
| Synperonic | | | |
| CDH-dispersion in | 5% NMP | 95 | 20-30 |
| Synperonic | | | |

Remarks relating to Table B
^{a)}pot-life of the coating mixture.
^{b)}Tested after a storage time of the coating mixture of 74 hrs at 50° C.
^{c)}Dispersion was equilibrated for 24 hrs after the addition of the additive.
^{d)}pot-life in hrs at 50° C.

The results show that:

the reaction temperature can be decreased by the addition of a low percentage of water to the polyurethane.

the reaction temperature can be increased slightly by the addition of NMP to the polyurethane.

the reaction temperature can be decreased by the addition of 5% Marlipal O 13/120 or Aerosol OT to the CDH-dispersion and the addition of 5% water to the polyurethane.

the reaction temperature can be decreased slightly by the addition of 5% Aerosol OT 100 to the CDH-dispersion and the addition of 5% NMP to the polyurethane.

the reaction temperature can be increased by the addition of the more reactive polyisocyanates HDI and TDI to the polyurethane. At a higher percentage the effect is stronger. The effect is weaker for the less reactive polyisocyanates IPDI and Des W.

the reaction temperature can be greatly increased by storing the coating mixture with additional HDI at 50° C. for 74 hrs.

when water is added to the polyurethane, the pot-life of the coating mixture will shorten.

when a more reactive polyisocyanate such as HDI or TDI is added to the polyurethane, the pot-life of the mixture will be greatly extended.

the reaction temperature is slightly higher when a water-soluble medium is used for the CDH-dispersion than when Bisoflex TOT is applied.

### Example 7

### Evaluation of the Effect on the Reaction Temperature Needed for the Formation of a Polyurethane Coating from the Coating Mixture After the Addition of a Surfactant and/or Water to a Dispersion of a Compound Containing a Reactive Hydrogen

The procedure of Example 5 was repeated, while in his example Triton X-100 and/or water were added to the dispersion of the carbodihydrazide, prior to the preparation of the coating mixture. In this case the isocyanate-functional polyurethane of Example 3 was used. After the addition of water to the CDH-dispersion the mixture was equilibrated for 24 hrs (which means stored in order to reach an equilibrium) before it was used in the coating mixture. The results are presented in Table C.

TABLE C
Effect of additives on the coating formation of
the aliphatic isocyanate-functional polyurethane of
Example 3 and a carbodihydrazide dispersion.

| | additive | minimal | |
|---|---|---|---|
| Triton X-100 | added to the | temperature | |
| in CDH | CDH- | complete | Pot-life |
| dispersion | dispersion | curing within 3 min | at 50° C.^{a)} |
| (weight %) | (weight %) | (° C.) | (hrs) |
| 0 | — | 90 | <0.8 |
| 0 | 1% water | 130 | 23-47 |
| 0 | 3% water | 135 | 23-96 |
| 0 | 5% water | 135 | 10-16 |
| 1 | — | 90 | <1 |
| 1 | 1% water | 110 | 6-22 |
| 1 | 3% water | 125 | 6-22 |
| 1 | 5% water | 135 | 16-20 |
| 2 | — | 90 | <0.5 |
| 2 | 1% water | 110 | 3-22 |
| 2 | 3% water | 125 | 47-96 |
| 2 | 5% water | 135 | 46-70 |
| 5 | — | 85 | <1 |
| 5 | 1% water | 85 | <1 |
| 5 | 3% water | 115 | 2-19 |
| 5 | 5% water | 125 | 10-17 |
| 5 | 5% NMP | 90 | <1 |

Remarks relating to Table C
^{a)}pot-life of the coating mixture.

The results show that:

the reaction temperature can be increased by the addition of water to the CDH dispersion. The effect is greater when more water is used.

by the addition of both water and Triton X-100 to the CDH-dispersion opposite effects are found: the reaction temperature will be increased by the addition of more water, while the temperature will be decreased by the addition of more Triton X-100.

The pot-life of the coating mixture can be lenghtened by the addition of water to the CDH-dispersion. This effect will be less in the presence of more Triton X-100.

### Example 8

### Evaluation of the Effect on the Reaction Temperature Needed for the Coating Mixture to Form a Polyurethane Coating After the Addition of Polyisocyanates to a Dispersion of a Compound Containing a Reactive Hydrogen

The procedure of Example 5 was repeated, while in this case an equivalent short measure of a polyisocyanate was added to the dispersion of CDH or ADH, prior to the preparation of the coating mixture. After the addition of the polyisocyanate to the CDH-dispersion or ADH-dispersion, the mixture was equilibrated for 24 hrs before it was used in the coating mixture. In this case isocyanate-functional polyurethanes of examples 1 and 3 were used, The results are presented in Table D and E.

TABLE D
Effect of a short measure of polyisocyanates in
the ADH-dispersion on the coating formation using the
aliphatic isocyanate-functional polyurethane of Example 1
and 3 and an ADH-dispersion.

| | | minimal | Pot-life at |
|---|---|---|---|
| | additive added | temperature | 50° C. |
| | to the ADH | complete curing | between^{a)} |
| polyurethane | dispersion | within 3 min (° C.) | (hrs) |
| Example 1 | — | 125 | >500 |
| | 0.02 SA HDI | 125 | >500 |
| | 0.10 SA HDI | 130 | >500 |
| | 0.02 SA N3300 | 130 | >500 |
| | 0.05 SA N3300 | 135 | >500 |
| Example 3 | — | 120 | >500 |
| | 0.02 SA HDI | 135 | >500 |
| | 0.10 SA HDI | 140 | >500 |
| | 0.02 SA N3300 | 135 | >500 |
| | 0.05 SA N3300 | 145 | >500 |

TABLE E
Effect of a short measure of polyisocyanates in
the CDH-dispersion on the coating formation from the
aliphatic isocyanate-functional polyurethane of Example 1
and 3 and a CDH-dispersion.

| | | coating- | minimal | |
|---|---|---|---|---|
| | | mixture | temperature | |
| | | at | complete | Pot-life |
| polyurethane | additive added | 50° C. | curing within | at 50° C. |
| from | to the | during | 3 min | between^{a)} |
| Example | CDH-dispersion | (hrs) | (° C.) | (hrs) |
| Example 1 | — | 0 | 85 | >384 |
| | 0.02 SA HDI | 0 | 110 | >384 |
| | 0.02 SA IPDI | 0 | 135 | >384 |
| | 0.02 SA TDI | 0 | 125 | >384 |
| Example 3 | — | 0 | 90 | 0-0.8 |
| | 0.001 SA HDI | 0 | 95 | 1-2 |
| | 0.001 SA HDI + 0.5% | 0 | 130 | 90-120 |
| | water | | | |
| | 0.01 SA HDI | 0 | 100 | 21-96 |
| | 0.01 SA HDI | 74 | 100 | |
| | 0.05 SA HDI | 0 | 120 | >864 |
| | 0.05 SA HDI | 74 | 120 | |
| | 0.10 SA HDI | 0 | 120 | >864 |
| | 0.10 SA HDI | 72 | 120 | |
| | 0.10 SA product | 0 | 110 | 168-288 |
| | Example 1 | | | |
| | 0.10 SA product | 168 | 115 | |
| | Example 1 | | | |
| | 0.01 SA TDI | 0 | 120 | 432-648 |
| | 0.01 SA TDI | 92 | 120 | |
| | 0.05 SA TDI | 0 | 125 | 21-92 |
| | 0.05 SA TDI | 92 | 120 | |
| | 0.01 SA IPDI | 0 | 120 | 18-93 |
| | 0.01 SA IPDI | 93 | 115 | |
| | 0.05 SA IPDI | 0 | 125 | >648 |
| | 0.05 SA IPDI | 93 | 125 | |
| | 0.01 SA Des W | 0 | 125 | 73-168 |
| | 0.01 SA Des W | 73 | 125 | |
| | 0.05 SA Des W | 0 | 130 | 408-624 |
| | 0.05 SA Des W | 75 | 130 | |
| | 0.01 SA N-3300 | 0 | 120 | 92-168 |
| | 0.01 SA N-3300 | 92 | 120 | |
| | 0.05 SA N-3300 | 0 | 125 | >624 |
| | 0.05 SA N-3300 | 92 | 125 | |

Remarks relating to Table D and E
^{a)}The pot-life of the coating mixture is the time that the mixture remains liquid

The results show that:

the reaction temperature can be increased by the addition of a stoichiometric short measure of a polyisocyanate with a low molecular weight or an isocyanate-functional polyurethane to a CDH-dispersion, prior to the preparation of the coating mixture. The strongest effect is found with Des W, followed by IPDI, TDI, HDI and the polyurethane from Example 1.

the pot-life can be lenghtened by the addition of a stoichiometric short measure of polyisocyanate to the CDH-dispersion.

when the CDH dispersion is protected, the curing temperature of an non-equilibrated coating mixture is comparable to that of a coating mixture which is equilibrated at 50° C.

the reaction temperature is lower when CDH is used than when ADH is used and the effects of the additives are stronger when CDH is used.

### Example 9

### Evaluation of the Effects on the Reaction Temperature to Prepare a Polyurethane Coating From a Coating Mixture After the Addition of Several Additives to a Dispersion of a Compound Containing a Reactive Hydrogen

The procedure of Example 5 was repeated, while in this Example PEC-205 (a polyketonediol), MEK (a ketone), EAP (an acid), DABCO (tertiairy amine), isophorondiamine, butanediol, an aromatic or aliphatic polycarbodiimide solution (in Table F presented as aliph-carb en arom-carb) and/or DBTL (a tin compound) was added to the dispersion of the carbodihydrazide, prior to the preparation of the coating mixture. In several cases water was added as well. The polycarbodiimides were prepared according to EP-507407 Example 18 and 32, and the intermediate isocyanate-functional polycarbodiimides were capped with an equivalent amount of n-propanol. After the addition of the additives to the CDH-dispersion the mixtures were equilibrated for 24 hrs at 20° C. before they were used in the coating mixture. When PEC-205 was used the temperature for equilibration was 50° C. The isocyanate-functional polyurethanes of Example 1 and 3 were used. The results are presented in Table F.

TABLE F
Effect of additives in the CDH-dispersion on the
coating formation using the aliphatic isocyanate-
functional polymer of Example 3 and a CDH-dispersion.

| | | minimal | Pot-life |
|---|---|---|---|
| | | temperature | at |
| | | complete | 50° C. |
| | Additive added to the | curing within | between^{a)} |
| polyurethane | CDH-dispersion | 3 min (° C.) | (hrs) |
| Example 1 | — | 90 | >500 |
| | 0.001 SA PEC-205 | 95 | >500 |
| | 0.002 SA PEC-205 | 95 | >500 |
| | 0.002 SA PEC-205 + 0.5% | 100 | >500 |
| | water | | |
| | 0.002 SA PEC-205 + 0.5% | 125 | >500 |
| | water + 0.15% EAP | | |
| | 1.5% EAP | 100 | >500 |
| | 1.5% DABCO | 95 | >500 |
| | 0.45% DBTL | 90 | >500 |
| | 0.02 SA butanediol | 95 | >500 |
| | 0.02 SA butanediol + 0.5% | 100 | >500 |
| | water | | |
| | 0.02 SA isophorone- | 120 | >500 |
| | diamine | | |
| | 0.02 SA isophorone- | 145 | >500 |
| | diamine + 0.5% water | | |
| | 2% Cymel-303 | 90 | >500 |
| Example 3 | — | 95 | 3-4 |
| | 0.001 SA PEC-205 | 100 | 24-48 |
| | 0.002 SA PEC-205 | 105 | 24-48 |
| | 0.002 SA PEC-205 + 0.5% | 125 | 24-48 |
| | water | | |
| | 0.002 SA PEC-205 + 0.5% | 120 | 24-48 |
| | water + 0.15% EAP | | |
| | 1% butanone | 105 | 24-48 |
| | 1.5% EAP | 115 | 24-48 |
| | 1.5% DABCO | 95 | 2-3 |
| | 0.45% DBTL | 95 | 2-3 |
| | 2% Cymel-303 | 100 | 1 |
| | 0.005 SA piperazine | 105 | 5-22 |
| | 0.02 SA piperazine | 105 | 5-21 |
| | 0.10 SA piperazine | 110 | 5-20 |
| | 0.5% aliph-carb | 105 | 1-23 |
| | 2.0% aliph-carb | 110 | 1-23 |
| | 5.0% aliph-carb | 115 | 1-21 |
| | 0.5% arom-carb | 100 | 2-18 |
| | 2.0% arom-carb | 100 | 4-8 |
| | 5.0% arom-carb | 105 | 7-23 |
| | 0.5% arom-carb + 0.5% | 125 | 6-22 |
| | water | | |
| | 2.0% arom-carb + 0.5% | 125 | 4-20 |
| | water | | |
| | 5.0% arom-carb + 0.5% | 125 | 3-19 |
| | water | | |

Remarks relating to Table F:
^{a)}Pot-life of the coating mixture

The results show that:

the reaction temperature can be increased by the addition of an equivalent short measure of a polyketonediol. The effect is stronger when water is added too and most pronounced when both water and acid are added.

the reaction temperature can be increased by the addition of an acid, an amine- or an OH-functional compound, or an aliphatic or aromatic polycarbodiimide solution. When water is added as well, the effect is stronger.

the pot-life is increased by the addition of a polyketonediol, water and/or acid.

### Example 10

### Evaluation of the Effect on the Reaction Temperature Where a Polyurethane Coating is Formed From a Coating Mixture and of the Effect of Added Solvents After the Equilibration Time of the Mixture of a Short Measure of a Polyisocyanate and a Dispersion of a Compound Containing a Reactive Hydrogen

The procedure of Example 5 was repeated, while in this example a short measure of HDI was added to the dispersion of CDH, prior to the preparation of the coating mixture. After the addition of HDI to the CDH-dispersion the mixtures were equilibrated for various periods of time, before they were used in the coating mixture. The isocyanate-functional polyurethane of Example 3 was used in the tests. The results are presented in Table G. Further, CDH-dispersions and CDH-dispersions treated with HDI were mixed with a solvent and equilibrated for at least 90 hrs and used according to the procedure of Example 5. The results are also presented in Table G.

TABLE G
the effect of the equilibration time of the
mixture of a short measure of HDI and a dispersion of CDH
on the reaction temperature of the formation of a
polyurethane coating using a coating mixture and the
effect of the addition of solvents to the CDH-dispersion

| | | equilibration | minimal | |
|---|---|---|---|---|
| Additive | solvent | time CDH- | temperature | Pot-life |
| added | added to | dispersion + | complete | at 50° C. |
| to the | the CDH- | HDI and/or | curing within | between^{b)} |
| CDH-dispersion | dispersion | solvent (hrs) | 3 min (° C.) | (hrs) |
| — | — | — | 90 | 0-0.8 |
| 0.02 SA HDI | — | 0 | 90 | 0.5-0.8 |
| 0.02 SA HDI | — | 0.2 | 95 | 20-168 |
| 0.02 SA HDI | — | 1 | 100 | 20-168 |
| 0.02 SA HDI | — | 16 | 110 | 168-240 |
| 0.02 SA HDI^{a)} | — | 16 | 120 | 168-240 |
| 0.02 SA HDI | — | 90 | 125 | 168-240 |
| 0.02 SA HDI | — | 360 | 125 | 168-240 |
| 0.02 SA HDI | — | 432 | 125 | 168-240 |
| — | 2% | 90 | 100 | 2-6 |
| | isohexane | | | |
| — | 2% toluene | 90 | 105 | 6-28 |
| — | 2% NMP | 90 | 100 | 5-28 |
| — | 2% EtOAc | 90 | 100 | 4-27 |
| 0.02 SA HDI | 2% | 90 | 125 | >240 |
| | isohexane | | | |
| 0.02 SA HDI | 2% toluene | 90 | 125 | >240 |
| 0.02 SA HDI | 2% NMP | 90 | 130 | 3-70 |
| 0.02 SA HDI | 2% EtOAC | 90 | 125 | >240 |
| 0.02 SA HDI | 20% | 90 | 125 | >240 |
| | isohexane | | | |
| 0.02 SA HDI | 20% | 90 | 125 | >144 |
| | toluene | | | |
| 0.02 SA HDI | 20% NMP | 90 | 110 | 3 |
| 0.02 SA HDI | 20% EtOAc | 90 | 130 | 43-136 |

remarks relating to Table G:
^{a)}coating mixture after 74 hrs at 50° C., in which a CDH-dispersion with HDI is used which is equilibrated for 16 hrs
^{b)}Pot-life of the coating mixture

The results show that:

a higher reaction temperature can be obtained by equilibrating the CDH-dispersiton with HDI for a longer period.

after a definite length of time of equilibration of the

the pot-life of the coating mixture is lenghtened by a longer equilibration period of the CDH-dispersion with HDI.

the reaction temperature can be increased to some extent by the addition of a solvent to the CDH-dispersion.

when a CDH-dispersion with HDI to which also a solvent is added is used, the reaction temperature is comparable to the material without solvent. Only in the presence of a larger amount of NMP the oligomer layer around the polyhydrazide dissolves or softens and the reaction temperature decreases again.

### Example 11

### Evaluation of the Effect of the Addition of Water or Acid to a Coating Mixture on the Reaction Temperature for the Formation of a Hydrazone Coating

PEC-205 was mixed with a, with respect to the ketone amount (1.87 meq/g), equivalent amount of a 4:6 by weight dispersion of carbodihydrazide or adipic dihydrazide in polypropylene glycol with a moleculair weight of 2000. Water and/or acid was added to the mixture. Further, the completely equilibrated CDH-dispersion with 0.02 SA HDI from Example 6 was mixed with PEC-205. The mixtures were spread onto an infrared cell and the cell was placed for 2, 3, 5, 8, 12, 20, 40, 60 or 90 min at different temperatures. The time to complete the reaction was tested by infrared spectroscopy. When ADH was used the signal at 1630 cm⁻¹ disappeared and a signal appeared at 1740 cm⁻¹. When CDH was used the signal at 1637 cm⁻¹ disappeared and a signal at 1740 cm⁻¹ appeared. The results are presented in Table H.

TABLE H
Effect of water and acid on the coating formation
using a polyketonediol and a carbodihydrazide dispersion
or an adipic dihydrazide dispersion.

| Compound | | | complete |
|---|---|---|---|
| containing a | | Reaction | curing |
| reactive | additive added to the | temperature | within |
| hydrogen | coating mixture | (° C.) | (min) |
| ADH- | — | 120 | 90 |
| dispersion | 2% water | 120 | 60 |
| | 5% water | 120 | 60 |
| | — | 140 | 60 |
| | 2% water | 140 | 20 |
| | 5% water | 140 | 20 |
| | — | 160 | 20 |
| | 2% water | 160 | 8 |
| | 5% water | 160 | 5 |
| | 2% (20% p-TSA in water) | 160 | 3 |
| | 2% (20% p-TSA in DMM) | 160 | 3 |
| | — | 190 | 8 |
| | 2% water | 190 | 5 |
| | 5% water | 190 | 5 |
| CDH- | — | 160 | 40 |
| dispersion | 2% water | 160 | 40 |
| | 2% (20% p-TSA in water) | 160 | 8 |

The results show that:

A quicker reaction can be obtained by increasing the reaction temperature, and/or by the addition of water and/or an acid.

### Example 12

### Evaluation of the Effect on Two-step Reactions Which are Executed with the Product of Example 4 After the Addition of Several Additives to a Dispersion of a Compound Containing a Reactive Hydrogen

50 g of the product of Example 4 was mixed with a, with respect to the NCO-amount, equivalent amount of a 4:6 (w/w) dispersion of CDH in Bisoflex TOT and with 1 g of a black pigment dispersion (obtainable as PermaQure GP-7715 from Stahl Holland). Beforehand several additives were added to the dispersion of CDH or to the coating mixture. The obtained mixtures were spread as 500 μm films onto a pre-heated plate. The temperature was serially raised by of 5° C. (±1° C.) at a time. After 3 min the progress of the reactions was checked. The lowest temperature required to obtain a dry and flexible film was measured. The results are presented in Table I. Next the films were embossed by pressing a pattern into them for 20 sec at 200° C. and 6.10⁵ Pa (6 atm). Thereafter the films were further cured by exposure to UV-radiation at 240 nm and a total energy amount of 4000 mJ/cm. The embossed films were placed for 24 hrs at 120° C. to test the stability of the grain. The results are presented in Table I.

TABLE I
Effect of additives on the two-step reaction
executed with the product of Example 4.

| | | | | films | |
|---|---|---|---|---|---|
| added | | minimal | emboss- | exposed | grain |
| to the | Added to | temperature | ability | to | stability |
| coating | the CDH- | complete | of the | UV- | at |
| mixture | dispersion^{a)} | curing | films | radiation | 120° C. |
| — | — | 90 | good | no | moderate |
| | | | good | yes | good |
| 3% | — | 80 | good | no | moderate |
| water | | | | | |
| | | | good | yes | good |
| — | 0.05 SA HDI | 120 | good | no | moderate |
| | | | good | yes | good |
| — | 1% water | 130 | good | no | moderate |
| | | | good | yes | good |

Remarks relating to Table I
The CDH-dispersion with additives was equilibrated for 24 hrs at 50° C.

The results show that:

the addition of water to the coating mixture allows the reaction temperature of the first reaction step to be decreased; which means the stage during which the film is formed.

the addition of water or HDI to the CDH-dispersion may cause the reaction temperature of the first reaction step to be increased; which means the stage during which the film is formed.

the additives have no influence on the embossability.

the stability of the grain in the films is much better when the films are exposed to UV-radiation in a second reaction step.

### Example 13

### Evaluation of the Two-step Reaction Between the Product of Example 1 and a Mixture of a CDH-dispersion and a CDH-dispersion Which is Treated with HDI

The isocyanate-functional polyurethane prepolymer of Example 1 was mixed with a CDH-dispersion in Bisoflex (4:6 w/w), a CDH dispersion which was treated with HDI and equilibrated for 95 hrs from Example 10, or a mixture of these two dispersions in a ratio of 0.5:0.5 SA. Films were spread onto a pre-heated plate and after 3 min the film was checked to see if it was still wet, tacky because of the formation of the film was not completed, or if the film formation was completed. The results are presented in Table J.

TABLE J
Results of the two-step reaction between the
product of Example 1 and a mixture of a CDH-dispersion and
a CDH-dispersion which is treated with HDI.

| | phase of the film within | | |
|---|---|---|---|
| | 3 min at a temperature of | | |
| compound containing reactive | | | cured |
| hydrogen | wet | tacky | film |
| 1.0 SA CDH-dispersion | 20-75 | 80-85 | 90 |
| 1.0 SA (CDH-dispersion with 0.02 SA | 20-90 | 95-105 | 110 |
| HDI) | | | |
| 0.5 SA CDH-dispersion + 0.5 | 20-85 | 90-105 | 110 |
| SA (CDH-dispersion with 0.02 SA | | | |
| HDI) | | | |
| 0.8 SA CDH-dispersion + 0.2 | 20-80 | 85-100 | 105 |
| SA (CDH-dispersion with 0.02 SA | | | |
| HDI) | | | |

The results show that

the reaction temperature can be increased by the addition of HDI to the CDH-dispersion.

when a mixture is used of the CDH-dispersion and a mixture of the CDH dispersion which was treated with HDI, a first reaction takes place at a lower temperature, so that the initial film is still tacky and sticky and the second reaction takes place at a higher temperature.

### Example 14

### Evaluation of the Two-step Reaction Between the Product of Example 3 and a Mixture of a CDH Dispersion and a CDH Dispersion Which was Treated with HDI

The isocyanate-functional polyurethane prepolymer of Example 3 was mixed with a CDH-dispersion in Bisoflex (4:6 w/w) and a CDH dispersion which was treated with HDI and equilibrated for 95 hrs from Example 10, in a ratio of 0.7:0.3 equivalent. A film was spread onto a pre-heated plate at 100° C. and after 3 min the film was removed. Subsequently the film was embossed by pressing a pattern in it for 20 sec at 200° C. and 6.10⁵ Pa (6 atm). The embossed film was then heated for 24 hours at 120° C. to check the stability of the grain. A film in which only the CDH-dispersion in Bisoflex was used as compound containing a reactive hydrogen was used as standard for comparison. The reactions were executed with or without water in the coating mixture. The results are presented in Table K.

TABLE K
Results of the two-step reaction between the
product of Example 3 and a mixture of a CDH-dispersion and
a CDH dispersion which was treated with HDI.

| | Added | curing of | | |
|---|---|---|---|---|
| | additive to | the first | emboss- | grain |
| Compound | a coating | reaction | ability | stability |
| containing | mixture | step | of the | at |
| reactive hydrogen | (weight %) | (° C.) | films | 120° C. |
| 1.0 SA CDH- | — | 95 | moderate | grain |
| dispersion | | | | stays as |
| | | | | it was |
| 1.0 SA CDH- | 3% water | 80 | moderate | grain |
| dispersion | | | | stays as |
| | | | | it was |
| 0.7 SA CDH- | — | 95 | good | good |
| dispersion + 0.3 | | | | |
| SA (CDH-dispersion | | | | |
| with 0.02 SA HDI) | | | | |
| 0.7 SA CDH- | 3% water | 80 | good | good |
| dispersion + 0.3 | | | | |
| SA (CDH-dispersion | | | | |
| with 0.02 SA HDI) | | | | |

The results show that:

The films which were prepared with only the CDH-dispersion have reacted and crosslinked so far that they cannot be embossed anymore. This appeared to be the case for both the films with and without the addition of water to the coating mixture.

For the films in which water was present in the coating mixture the reaction temperature of the first step can be decreased.

The films, in which a part of the compound containing a reactive hydrogen is treated with HDI, are still embossable after the first reaction step and only cure completely during embossing at 200° C.

What is claimed is:

1. A process for preparation of a coating, coated substrate, film or sheet, in which process a coating mixture comprising a reactive system of a polyisocyanate-functional, polyketone-functional, polyepoxide-functional, polyanhydride-functional and/or polycyclic carbonate-functional compound or polymer and a dispersion or fine powder of a compound containing a reactive hydrogen, which mixture is not or low-reactive at room temperature, is applied onto a substrate at ambient temperature, resulting in a substrate coated with the coating mixture, followed by reacting the compounds mentioned above by elevating the temperature, wherein the reaction temperature, which is 50 to 300° C. and is maintained for 1 to 20 minutes without selected additives, is adjusted to a temperature which is 3-50° C. higher or lower than said temperature in a similar reaction time by addition of an additive to the coating mixture, prior to elevating the temperature or to one of the reactants of the coating mixture prior to the mixing with the other component.

2. A process according to claim 1, wherein the compound containing the reactive hydrogen is a compound which is crystalline at a temperature below 90° C.

3. A process according to claim 1, wherein the compound containing a reactive hydrogen is a polyhydrazide and/or or polysemicarbazide and is preferably adipic dihydrazine or carbodihydrazide.

4. A process according to claim 1, wherein the additive is water, acid, base, a metal catalyst, a solvent, a polyisocyanate-functional compound, a polyketone-functional compound, a melamine and/or a surfactant.

5. A process according to claim 1, wherein concentration, temperature, sequence of the addition of additives, separate, prior addition of the additives to one of the reactants of the coating mixture, and/or equilibration time of the additives in the coating mixture or in one of the reactants of the coating mixture are factors that control the reaction.

6. A process according to claim 1, wherein reaction rate is increased by addition of water, an acid, a base, or a metal catalyst, together with a surfactant, to the coating mixture, and a coating is formed at a temperature which is 3-50° C. below the original temperature.

7. A process according to claim 1, wherein the reaction is delayed by addition of 0.0001-10 weight % of water and/or acid, amine, polyamine, alcohol or polyol to a dispersion of the compound containing a reactive hydrogen prior to mixing it with the polyisocyanate-functional compound, and a coating is formed at a temperature that is 3-50° C. higher than the original temperature.

8. A process according to claim 1, wherein the reaction is delayed by addition of 0.002-0.20 equivalents of a polyisocyanate-functional compound, such as 1,6-hexanediisocyanate, tuluenediisocyanate, 4,4′-diisocyanatocyclyohexylmethane, 4,4′-diisocyanatophenylmethane, 3-isocyanatomethyl-3,5,5,-trimethylcyclohexylisocyanate, tetramethylxylenediisocyanate, a (triisocyanatoalkyl- or cycloalkyl)-isocyanurate, a diisocyanato-alkyl- or cycloalkyl) uretdion or a isocyanate-functional polyurethane based on said diisocyanates, and/or an alphatic or aromatic polycarbodiimide and/or an organic solvent, to a dispersion of the compound containing a reactive hydrogen prior to the mixing with a polyisocyanate-functional compound, and a coating is formed at a temperature that is 3-50° C. higher than the original temperature.

9. A process according to claim 8, wherein the reaction is delayed by addition of 0.002-0.20 equivalents a polyisocyanate-functional compound with a low molecular weight to an isocyanate-functional polymer prior to mixing with the compound containing a reactive hydrogen, and a coating is formed at a temperature of 3-30° C. higher than the original temperature.

10. A process according to claim 1, wherein the reaction is delayed by addition of 0.001-0.20 equivalent of an aldehyde, polyaldehyde, ketone- and or polyketone-functional compound to a dispersion of the compound containing a reactive hydrogen prior to the mixing with a polyisocyanate-functional compound, and a coating is formed at a reaction temperature which is 3-50° C. higher than the original reaction temperature.

11. A process according to claim 1, wherein pot-life of coating mixtures is increased from 5-240 minutes up to at least 1 day.

12. A process according to claim 1, wherein a second reactive system is present and both systems are essentially reacted as a sequential two step reaction wherein between these reactions the coating is remoulded, wherein the second reactive system comprises on the one hand a ketone, anhydride, epoxide, a polyisocyanate with a different reactivity, a blocked isocyanate and/or a cyclic carbonate function, or the compound with the isocyanate functionality from claim 1, and on the other hand a hydrazide or semicarbazide with a lower reactivity or with a different size, an amine, a hindered amine, chlorinated amine, a polymer protected amine, blocked amine, azetidine, aspartate, carboxyl, aromatic amine, hydroxide and/or melamine function and/or that the other reactive system comprises polysiloxane or melamine functions which are polymerisable by self-condensation, and/or that the other reactive system comprises an unsaturated compound which undergoes an addition polymerization, in which the reactive groups from the second reactive system may be coupled to the compound containing a reactive hydrogen, or to the polyisocyanate-,polyketone-, polyepoxide, polyanhydride, and/or a polycyclic carbonate-functional compound or polymer of the first reactive system or to another compound.

13. A process according to claim 12, wherein the second reactive system reacts faster than the first reactive system in the presence of the additive.

14. A process according to claim 12, wherein the second reactive system reacts more slowly than the first reactive system in the presence of the additive.

15. A process according to claim 11, wherein the pot-life is increased up to at least 14 days.

16. Coating, coated substrate, film or sheet obtained by the process according to claim 1.
